(19) United States
(12) Patent Application Publication
(10) Pub. No.: US 2018/0052282 A1
(43) Pub. Date: Feb. 22, 2018

(54) DUAL POLARIZATION ARRAYED WAVEGUIDE GRATING

(71) Applicant: Lumentum Operations LLC, Milpitas, CA (US)

(72) Inventors: Barthelemy FONDEUR, San Jose, CA (US); Shibnath PATHAK, San Jose, CA (US)

(21) Appl. No.: 15/240,047

(22) Filed: Aug. 18, 2016

(51) Int. Cl. G02B 6/12; G02B 6/126; G02B 6/27; G02B 6/293

(52) U.S. Cl. CPC G02B 6/12014; G02B 6/126; G02B 6/2938; G02B 6/29329; G02B 6/2726

(57) ABSTRACT

A 1×N demultiplexer may include an input slab to distribute an input beam, including one or more wavelengths of light, among waveguides of a waveguide array. The wavelengths of light may comprise TE polarized light and TM polarized light. The 1×N demultiplexer may include the waveguide array to propagate a plurality of beams via the waveguides. The 1×N demultiplexer may include an output slab to cause N TE polarized beams and N TM polarized beams to be formed based on the plurality of beams. The 1×N demultiplexer may include a set of N TE output ports and a set of N TM output ports coupled to the output slab. A TE output port may receive a TE polarized beam of the N TE polarized beams. A TM output port may receive a TM polarized beam of the N TM polarized beams.

### TECHNICAL FIELD

The present disclosure relates to an arrayed waveguide grating (AWG) used as a 1×N demultiplexer for demultiplexing an input beam and, more particularly, a 1×N demultiplexer with 2N outputs, where a first group of N outputs are to output transverse-electric (TE) polarized beams of light and a second group of N outputs are to output transverse-magnetic (TM) polarized beams of light.

### BACKGROUND

An arrayed waveguide grating (AWG) is a commonly used type of optical device for demultiplexing an input beam into N output beams (i.e., a 1×N demultiplexer), where each of the N output beams includes a different wavelength of light. A typical AWG includes an input port, an input slab, a waveguide array, an output slab, and N output ports. The waveguide array typically includes multiple curved waveguides of incrementally different lengths. Here, the input port is coupled to a first end of the input slab, a second end of the input slab is coupled to a first end of the waveguide array, a second end of the waveguide array is coupled to a first end of the output slab, and a second end output slab (i.e., an output surface) is coupled to the N output ports.

During operation, the input slab receives the input beam via the input port, and distributes the input beam among the waveguides of the waveguide array. The waveguides propagate corresponding beams of light (i.e., portions of the input beam), each including multiple wavelengths of light, to the first end of the output slab. Here, phase delays are introduced to each of the beams of light due to the incrementally different lengths of the waveguides. The phase delays introduced by the waveguides of the waveguide array vary among the waveguides due to the incrementally different lengths, and are wavelength dependent (i.e., different for each wavelength).

After propagation of the beams of light via the waveguide array, propagation of the beams of light within the output slab causes interference patterns, corresponding to each of the multiple wavelengths of light, to be created. Since the phase delays introduced by the waveguides of the waveguide array are wavelength dependent, the interference patterns are wavelength dependent (i.e., the interference patterns are different for each of the multiple wavelengths). The interference patterns result in points of constructive interference being formed at the second end of the output slab. Here, each of the multiple wavelengths may have a different point of constructive interference at the output end of the output slab. The N output ports are arranged at the points of constructive interference corresponding to each of the multiple wavelengths of light. This allows each output port, of the N output ports, to receive a higher amount of light of a particular wavelength (e.g., as compared to other wavelengths of light received at the output ports), and provide a corresponding output beam of the N output beams. Arrayed waveguide gratings are typically designed for a single polarization of light (i.e. TE polarized light or TM polarized light).

### SUMMARY

According to some possible implementations, a 1×N demultiplexer, may include: an input slab to distribute an input beam, including one or more wavelengths of light, among a plurality of waveguides of a waveguide array, where a wavelength of light, of the one or more wavelengths of light, may comprise transverse-electric (TE) polarized light and transverse-magnetic (TM) polarized light; the waveguide array to propagate, to an output slab, a plurality of beams via the plurality of waveguides, where the plurality of beams may be formed by the distribution of the input beam within the input slab to the plurality of waveguides; the output slab to cause a set of N TE polarized beams and a set of N TM polarized beams to be formed based on interference among the plurality of beams within the output slab, where a TE polarized beam, of the set of N TE polarized beams, may include the TE polarized light of the wavelength of light, and where a TM polarized beam, of the set of N TM polarized beams, may include the TM polarized light of the wavelength of light; and a set of N TE output ports and a set of N TM output ports coupled to the output slab, where a TE output port, of the set of N TE output ports, may receive the TE polarized beam of the set of N TE polarized beams, and where a TM output port, of the set of N TM output ports, may receive the TM polarized beam of the set of N TM polarized beams.

According to some possible implementations, an optical device may comprise: an input slab to distribute an input beam, including one or more wavelengths of light, among a plurality of waveguides of a waveguide array, where a wavelength of light, of the one or more wavelengths of light, may comprise transverse-electric (TE) polarized light and transverse-magnetic (TM) polarized light; the waveguide array to propagate, to an output slab, a plurality of beams via the plurality of waveguides, where the plurality of beams may be formed based on the distribution of the input beam among the plurality of waveguides by the input slab; the output slab to form a set of TE polarized beams and a set of TM polarized beams based on interference among the plurality of beams within the output slab, where a TE polarized beam, of the set of TE polarized beams, may include the TE polarized light of the wavelength of light, and where a TM polarized beam, of the set of TM polarized beams, may include the TM polarized light of the wavelength of light; and a set of output ports, coupled to the output slab, to output the set of TE polarized beams and the set of TM polarized beams, where a first subset of output ports, of the set of output ports, may output the set of TE polarized beams, and a second subset of output ports, of the set of output ports, to output the set of TM polarized beams, where the first subset of output ports may be different from the second subset of output ports.

According to some possible implementations, a method may comprise: distributing, by an input slab of an optical device, an input beam among waveguides of a waveguide array of the optical device, where the input beam may include multiple wavelengths of light, where a wavelength of light, of the multiple wavelengths of light, may comprise transverse-electric (TE) polarized light and transverse-magnetic (TM) polarized light; propagating, by the waveguide array and to an output slab of the optical device, a plurality of beams via the waveguides, where the plurality of beams may be formed by the distributing of the input beam among the waveguides; forming, by the output slab and based on the plurality of beams, a set of TE polarized beams and a set of TM polarized beams, where a TE polarized beam, of the set of TE polarized beams, may include the TE polarized light of the wavelength of light, and where a TM polarized beam, of the set of TM polarized beams, may include the TM polarized light of the wavelength of light; and outputting, by a plurality of outputs of the optical device, the set of TE polarized beams and the set of TM polarized beams, where a first set of outputs, of the plurality of outputs, may output the set of TE polarized beams, and where a second set of outputs, of the plurality of outputs, may output the set of TM polarized beams, where the first set of outputs may be different from the second set of outputs.

### BRIEF DESCRIPTION OF THE DRAWINGS

FIG. 1 is a diagram of an overview of example dual polarization AWG, for use as a 1×N demultiplexer, with 2N outputs including N TE polarized outputs and N TM polarized outputs;

FIG. 2 is a diagram of an example close-up view of an output slab, TE output ports, and TM output ports of the example dual polarization AWG of FIG. 1;

FIG. 3 is a diagram showing a manner in which N TE polarized outputs of the example dual polarization AWG of FIG. 1 may be combined with the N TM polarized outputs of the example dual polarization AWG of FIG. 1 in order to form N outputs; and

FIG. 4 is a flow chart of an example process associated with operation of the example dual polarization AWG of FIG. 1.

### DETAILED DESCRIPTION

The following detailed description of example implementations refers to the accompanying drawings. The same reference numbers in different drawings may identify the same or similar elements. The implementations described below are merely examples and are not intended to limit the implementations to the precise forms disclosed. Instead, the implementations were selected for description to enable one of ordinary skill in the art to practice the implementations.

A typical AWG may be formed of a birefringent material, such as a silicon. Birefringence is a property of a material that causes a refractive index of the material to depend on a polarization of light propagating through the material. For example, a given AWG formed of a birefringent material (e.g., silicon) may have a first set of refractive indices for TE polarized light, and a second (i.e., different) set of refractive indices for TM polarized light. Thus, phase delays of different wavelengths of TE polarized light and TM polarized light, when propagating the birefringent AWG, are polarization-dependent, making the design of the AWG more complex and/or difficult to realize in order to avoid polarization dependent wavelength shifts for light propagating the AWG.

One approach to overcome the polarization dependence caused by birefringence is use of a polarization diversity circuit comprising a two-dimensional (2-D) grating coupler. The polarization diversity circuit with the 2-D grating coupler operates by splitting light of an unknown polarization into two TE waveguides, using outputs of the two TE waveguides as inputs to a pair of demultiplexers, and combining outputs of the pair of demultiplexers with the 2-D grating coupler. However, coupling loss of the 2-D grating coupler is high and a bandwidth capability is limited (e.g., a few tens of nanometers (nm)), thus limiting practical use of this approach. For example, the polarization diversity circuit with the 2-D grating coupler is not practical for a demultiplexer including four channels with 20 nm spacing.

Another approach to overcome the polarization dependence caused by birefringence is a polarization diversity circuit that uses a polarization beam splitter and a polarization rotator. The polarization diversity circuit that uses the polarization beam splitter and the polarization rotator may reduce overall loss, but experiences significant polarization dependent loss (PDL). Here, the polarization rotator, when rotating TM polarized light to form TE polarized light, is a significant contributor to PDL. In order to avoid use of the polarization rotator, the polarization diversity circuit may instead include a single TE demultiplexer and a single TM demultiplexer (e.g., instead of two identical TE demultiplexers). However, fabrication of a TE demultiplexer and a TM demultiplexer with identical optical performance may be difficult and/or complex.

An additional approach to overcome the polarization dependence caused by birefringence is an AWG with a polarization compensation scheme. The polarization compensation scheme can be realized by forming waveguides of the waveguide array to have different widths (i.e., a width of a waveguide may vary along the waveguide). However, in a case where the material has significant birefringence (e.g., in a silicon-formed AWG), a waveguide length needed for compensation using this approach is significantly increased, which can result in a large AWG footprint, which may increase manufacturing complexity and/or cost, and negatively impact optical performance. Moreover, the AWG with the polarization compensation scheme may not adequately compensate for birefringence of slabs of the AWG. Thus, the AWG with the polarization compensation scheme may not be practical for an AWG formed of a material with significant birefringence characteristics, such as a silicon-formed AWG. Additionally, while the AWG with the polarization compensation scheme may be practical for a material for which waveguide birefringence is low and slab birefringence is negligible (e.g., a silicon nitride (Si₃N₄) formed AWG), integration between components formed of different materials (e.g., a Si₃N₄-formed AWG and other silicon-formed components) may be difficult and/or complex to realize.

Implementations described herein provide a dual polarization (i.e., polarization insensitive) AWG, for use as a 1×N demultiplexer, that includes 2N outputs, where a first set of N outputs provide TE polarized light for a set of N wavelengths, and a second set of N outputs provide TM polarized light for the set of N wavelengths. In some implementations, birefringence of a material from which the dual polarization AWG is formed may be accounted for in the design of the dual polarization AWG in order to allow for separation of the TE polarized outputs and the TM polarized outputs, as described below.

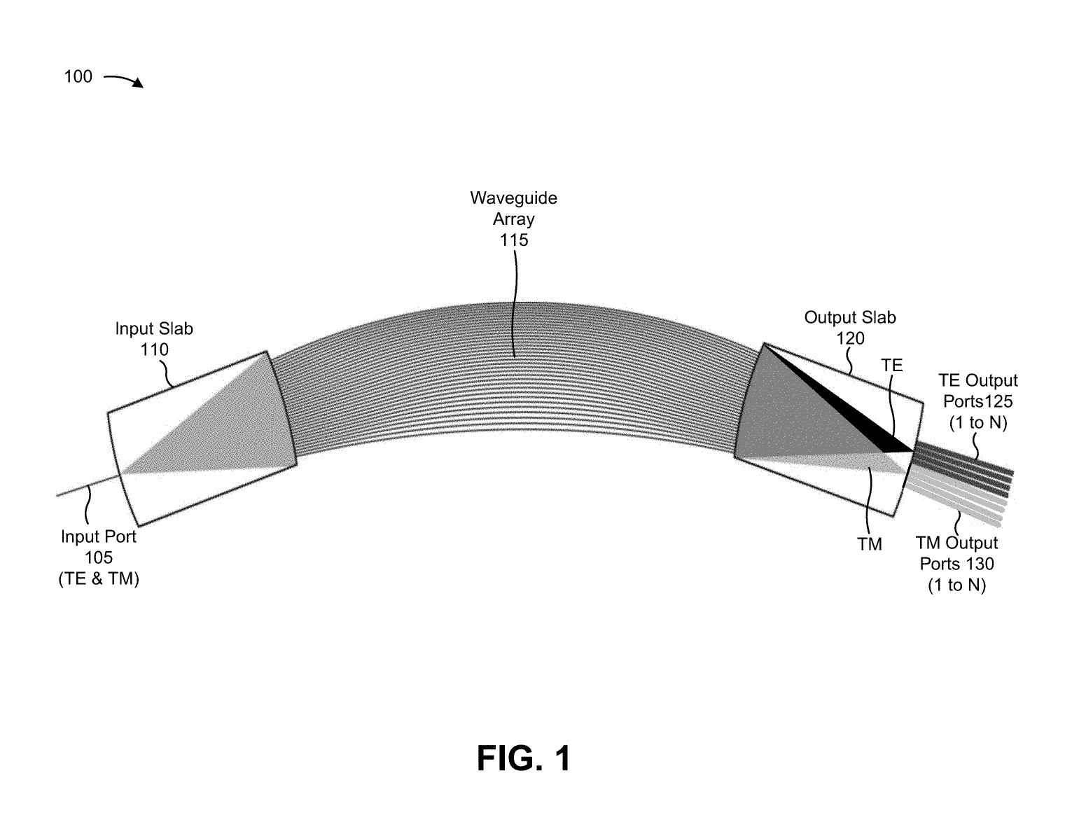

FIG. 1 is a diagram of an overview of an example dual polarization AWG, for use as a 1×N demultiplexer, with 2N outputs including N TE polarized outputs and N TM polarized outputs. As shown in FIG. 1, the dual polarization AWG (herein referred to as AWG 100) may include an input port 105, an input slab 110, a waveguide array 115, an output slab 120, a set of TE output ports 125 (e.g., TE output port 125-1 through TE output port 125-N (N>1)), and a set of TM output ports 130 (e.g., TM output port 130-1 through TM output port 130-N). Operation of AWG 100 is described below following descriptions of physical characteristics of the components of AWG 100.

In some implementations, the components of AWG 100 may be formed of a birefringent material via which light may be propagated, such as silicon, silica, silicon nitride, or the like. Additionally, or alternatively, the components of AWG 100 may be formed on a single chip of a wafer on which multiple AWGs 100 are formed (e.g., each AWG 100 may be formed on a different chip of the wafer).

Input port 105 includes an input waveguide arranged to receive an input beam of light for demultiplexing by AWG 100. In some implementations, the input beam may include multiple wavelengths of both TE polarized light and TM polarized light. As shown in FIG. 1, input port 105 may be coupled to input slab 110 (e.g., at an input end of input slab) such that the input beam may pass from input port 105 to input slab 110. In some implementations, the input waveguide may be an input fiber.

Input slab 110 includes a component (e.g. a portion of a chip from a fiber light couple, associated with input port 105, to the waveguides of waveguide array 115) arranged to receive the input beam from input port 105, and distribute the input beam among waveguides of waveguide array 115. Input slab 110 acts as a free-space region that allows the input beam to be distributed among the waveguides of waveguide array 115 such that waveguides of waveguide array 115 receive a portion of the input beam (where each portion of the input beam includes multiple wavelengths of both TE polarized light and TM polarized light). Distributing the input beam among waveguides of waveguide array 115 may include coupling a portion of all polarizations and all wavelengths of the input beam into each waveguide of waveguide array 115. In some implementations, input port 105, input slab 110, and ports associated with an input side of waveguide array 115 may be referred to as an input star-couple or an input free space region.

Waveguide array 115 includes an array of multiple waveguides via which beams of light, corresponding to the portions of the input beam received by each waveguide, are propagated. In some implementations, the waveguides of waveguide array 115 have incrementally different lengths. For example, a first waveguide of waveguide array 115 may have a first length, and a second waveguide of waveguide array 115, adjacent to the first waveguide, may have a second length. Here, a difference between the first length and the second length is a delay length (ΔL). A third waveguide of waveguide array 115, adjacent to the second waveguide and not adjacent to the first waveguide, may have a third length, where a difference between the second length and the third length is ΔL. In other words, waveguides of waveguide array 115 may have incrementally different lengths, where a difference in length between a given pair of adjacent waveguides is ΔL. As shown in FIG. 1, in some implementations, the multiple waveguides of waveguide array 115 may be formed to have a curved shape such that first ends of the waveguide array 115 may be aligned and second ends of the waveguide array 115 may be aligned while the length of each waveguide in the array incrementally increases. As further shown, waveguide array 115 may be coupled to an end of output slab 120.

Output slab 120 includes a component (e.g. a portion of a chip from waveguides of waveguide array 115, to a fiber light couple associated with an output of AWG 100) arranged to receive the beams of light propagated via the waveguides of waveguide array 115, and to cause interference patterns, associated with multiple wavelengths of light (and for each polarization of light), to be created during propagation within output slab 120. In other words, output slab 120 acts as a free-space region that allows these interference patterns to be formed. As shown, an end of output slab 120 may be coupled to TE output ports 125 and TM output ports 130. In some implementations, ports associated with an output side of waveguide array 115, output slab 120, and output ports of AWG 100 (e.g., TE output ports 125, TM output ports 130) may be referred to as an output star-couple or an output free space region.

TE output ports 125 include a set of N waveguides arranged to receive TE polarized light created by constructive interference within output slab 120. As shown in FIG. 1, the N TE output ports 125 are arranged at the end of output slab 120. Here, each TE output port 125 may be formed at a point of constructive interference corresponding to a particular wavelength of light. In other words, each TE output port 125 may be arranged to receive a different wavelength of TE polarized light (i.e., each TE output port 125 may be arranged at a point of highest constructive interference (e.g., a TE maxima) for a particular wavelength of TE polarized light). In some implementations, the set of N waveguides may be a set of N fibers.

TM output ports 130 include a set of N waveguides arranged to receive TM polarized light created by constructive interference within output slab 120. As shown in FIG. 1, the N TM output ports 130 are arranged at the end of output slab 120. Here, each TM output port 130 may be formed at a point of constructive interference corresponding to a particular wavelength of light. In other words, each TM output port 130 may be arranged to receive a different wavelength of TM polarized light (i.e., each TM output port 130 may be arranged at a point of highest constructive interference (e.g., a TM maxima) for a particular wavelength of TM polarized light). In some implementations, the TM output ports 130 may be a set of N fibers.

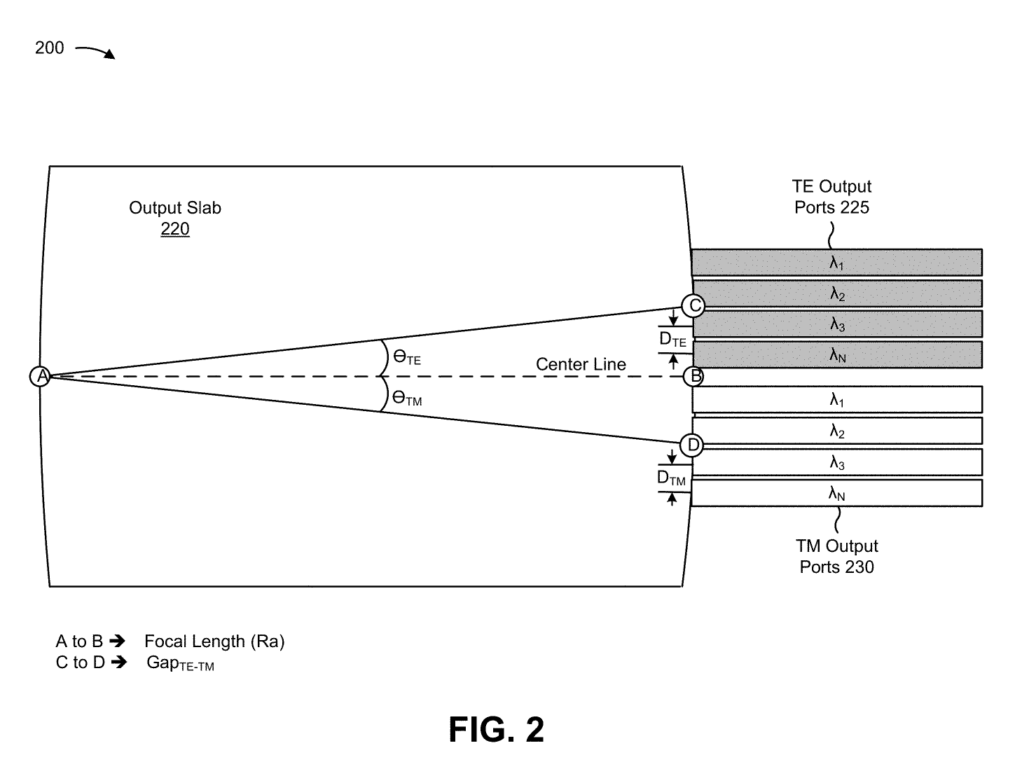

As shown in FIG. 1, TM output ports 130 may be adjacent to TE output ports 125 at the end of output slab 120. For example, as illustrated in FIG. 1, TM output ports 130 may be arranged such that TM output ports 130 are spatially separated form TE output ports 125. As another example, one or more TM output ports 130 may be interspersed between one or more TE output ports 125 (e.g., a TM output port 130 may be arranged between a pair of TE output ports 125). The arrangement of TE output ports 125 and TM output ports is described below in further detail with regard to FIG. 2.

During operation of AWG 100, input slab 110 receives, from input port 105, the input beam, including multiple wavelengths of both TE polarized light and TM polarized light, and distributes the input beam among waveguides of waveguide array 115 (e.g., illustrated in FIG. 1 by the triangular shape within input slab 110). Next, each waveguide of waveguide array 115 propagates a corresponding beam of light (i.e., a portion of the input beam received by the waveguide), thereby introducing phase delays to the beam of light (e.g., due to the incrementally different lengths of the waveguides), as described above. The phase-delayed beams of light are then propagated via output slab 120, resulting in an interference pattern, corresponding to each wavelength of light, being created.

Here, due to the birefringence of the material from which AWG 100 is formed (e.g., silicon), different phased delays are introduced for TE polarized light of a given wavelength and TM polarized light of the given wavelength. As such, different interference patterns are created for the TE polarized light of the given wavelength and the TM polarized light of the given wavelength (e.g., illustrated in FIG. 1 by the differently shaded triangular shapes within output slab 120). Thus, a point of constructive interference for TE polarized light of the given wavelength (e.g., illustrated in FIG. 1 as a right-most point of the triangle labeled “TE” in FIG. 1.) is at a different location at the end of output slab 120 than a point of constructive interference for TM polarized light of the given wavelength (e.g., illustrated in FIG. 1 as a right-most point of the triangle labeled “TM” in FIG. 1). As shown, a TE output port 125 and a TM output port 130 may be arranged at the points of constructive interference for the TE polarized light of the given wavelength and the TM polarized light of the given wavelength, respectively.

For purposes of clarity, FIG. 1 shows a single point of constructive interference for TE polarized light of a single wavelength (e.g., the given wavelength), and a single point of constructive interference for TM polarized light of the single wavelength. In practice, additional points of constructive interference may exist for a range of wavelengths of TE polarized light and TM polarized light, and the N TE output ports 125 and the N TM output ports may be arranged, accordingly (e.g., the N TE output ports 125 may be arranged at N points of constructive interference corresponding to N wavelengths of TE polarized light, and the N TM output ports 130 may be arranged at N points of constructive interference corresponding to N wavelengths of TM polarized light). Here, each TE output port 125 may output TE polarized light of a different wavelength, and each TM output port 130 may output TM polarized light of a different wavelength. In this way, AWG 100 may be designed with 2N outputs, where N outputs are TE polarized beams of light of N different wavelengths, and N outputs are TM polarized beams of light of the N different wavelengths.

In some implementations, the TE polarized light of a given wavelength, collected by TE output port 125, may be combined (e.g., at a photodetector or at an optical combiner) with the TM polarized light of the given wavelength, collected by a corresponding TM output port 130, in order to form an output that includes TE polarized light and TM polarized light of the given wavelength. In other words, N outputs may be formed by the combination of light collected by the N TE output ports 125 and the N TM output ports 130. In this way, N outputs may be formed from the 2N outputs of the dual polarization AWG 100.

Notably, the number, arrangement, widths, lengths, shapes, etc. of components of AWG 100 shown in FIG. 1 are provided as examples, and are exaggerated for illustrative purposes. In other words, AWG 100 may include additional components, fewer components, different components, differently arranged components, differently sized component, or the like, than those shown in FIG. 1.

In some implementations, AWG 100 may be designed such that, during operation of AWG 100, the N TE output ports 125 lie at different maxima of constructive interference corresponding to N different wavelengths of TE polarized light, and the N TM output ports 130 lie at different maxima of constructive interference corresponding to the N different wavelengths of TM polarized light.

For example, assume that AWG 100 is to include four TE output ports 125 (e.g., each to collect TE polarized light of one of four wavelengths) and four TM output ports 130 (e.g., each to collect TM polarized light of one of the four wavelengths), while maintaining a channel spacing (e.g., a difference in wavelength between light collected by adjacent outputs) of 20 nm (dλ=20 nm).

For the purposes of this example, assume that AWG 100 is to be formed of silicon, and is to have a thickness of 220 nm. Additionally, assume that a width of waveguides of waveguide array 115 is to be 300 nm and that a pitch of the waveguides at output slab 120 (e.g., a distance from a center of a first waveguide to a center of an adjacent waveguide) is to be 1 micron (da=1 micron). Finally, assume that AWG 100 is to be designed based on a center wavelength of 1310 nm (λ_{c}=1310 nm) (i.e., a spectrum in which AWG 100 is to operate is centered at 1310 nm). The birefringence properties of such a silicon-formed AWG 100 for a center wavelength of 1310 nm are as follows:

| | Waveguide refractive | Waveguide group | Slab refractive |
|---|---|---|---|
| Polarization | index (n_{wg}) | index (n_{g}) | index (n_{slab}) |
| TE | 2.235 | 4.61 | 2.93 |
| TM | 1.924 | 4.46 | 2.40 |

An initial step for designing AWG 100 is to determine a grating order (m) of AWG 100. A usable grating order may be determined based on calculating a free spectral range for the TE polarization (FSR_{TE}) and a free spectral range for the TM polarization (FSR_{TM}). The free spectral range is a largest wavelength range for a given grating order that does not overlap the same wavelength range in an adjacent grating order. For a given AWG design, the FSR should be greater than two times a number wavelength channels times the channel spacing in order to avoid overlap for the selected grating order. Thus, in this example, FSR_{TE} and FSR_{TM} should each be greater than 160 nm (e.g., 2×4×20 nm=160 nm).

In this example, assume that a second order is selected as the grating order (e.g., m=2). FSR_{TE} and FSR_{TM} may be determined using the following equations:

$${FSR}_{TE} = \frac{{n}_{wg \_ TE} \times {λ}_{c}}{m \times {n}_{g \_ TE}}$$

$${FSR}_{TM} = \frac{{n}_{wg \_ TM} \times {λ}_{c}}{m \times {n}_{g \_ TM}}$$

Here, FSR_{TE} is calculated as 317 nm (e.g., FSR_{TE}=(2.235×1310 nm)/(2×4.61)=317 nm), and FSR_{TM} is calculated as 282 nm (e.g., FSR_{TM}=(1.924×1310 nm)/(2×4.46)=282 nm). Since FSR_{TE} and FSR_{TM} are both greater than 160 nm, the second order (e.g., m=2) may be used for the design of AWG 100.

A next step for designing AWG 100 may include determining a delay length (ΔL) of waveguide array 115. The delay length of waveguide array 115 may be determined, based on the selected grating order, using the following equation:

$$Δ L = m \frac{{λ}_{c}}{{n}_{wg \_ TE}}$$

In this example, ΔL is calculated as 1.17 microns (e.g., 2×(1310 nm/2.235)=1170 nm=1.17 microns). Notably, ΔL is calculated for the TE polarization (e.g., based on n_{wg}_{_}_{TE}). In this example design, parameters of AWG 100 are determined for the TE polarization, and are then verified for the TM polarization, as described below, to ensure separation of the TE polarized outputs and the TM polarized outputs. Alternatively, in some implementations, the parameters of AWG 100 may be determined for the TM polarization and verified for the TE polarization.

A next step for designing AWG 100 may include determining a focal length (Ra) of output slab 120 for the TE polarization. The focal length is a length, from an end of output slab 120 (e.g., an end to which waveguide array 115 is coupled) to an opposite end of output slab 120 (e.g., an end to which TE output ports 125 and TM output ports 130 are coupled), along a center line of output slab 120. In some implementations, Ra may be within a range from approximately 20 microns to approximately 1000 microns. FIG. 2 is a diagram of an example close-up view of output slab 120, TE output ports 125, and TM output ports 130. As shown in FIG. 2, the focal length of output slab 120 may correspond to the dashed line between points marked “A” and

Here, assume that an output pitch of TE output ports 125 is desired to be 3.2 microns (e.g., D_{TE}=3.2 microns). The output pitch of TE output ports 125 corresponds to a distance from a first point of constructive interference, corresponding to a particular wavelength of TE polarized light of the N wavelengths of light to be output by AWG 100, to a second point of constructive interference corresponding to an adjacent wavelength of TE polarized light of the N wavelengths of light. In other words, the output pitch of the TE output ports 125 is a distance between adjacent TE polarized wavelength 2^{nd} order interference maxima of AWG 100. The output pitch of TE output ports 125 is shown by the distance marked “D_{TE}” in FIG. 2. The output pitch is selected in order to ensure that TE output ports 125 can be formed without overlap. In some implementations, D_{TE} may be within a range from approximately 0.5 microns to approximately 10 microns.

Continuing with the above example, the focal length may be determined, based on D_{TE}, using the following equation:

$${D}_{TE} = \frac{Ra \times m \times {n}_{g \_ TE}}{{n}_{slab \_ TE} \times {n}_{wg \_ TE} \times da} \times d λ$$

Here, Ra is calculated as 113.64 microns (e.g., 3.2 microns=[(Ra×2×4.61)/(2.93×2.235×1 micron)]×0.02 microns→Ra=113.64 microns). In this example, the focal length of output slab 120 causes the points of constructive interference of the N wavelengths of TE polarized light to be approximately 3.2 microns apart at the end of output slab 120. In some implementations, a same Ra is used for input slab 110 and output slab 120 (i.e., input slab 110 and output slab 120 have a same focal length).

In this way, AWG 100 may be designed for the TE polarization. The above parameters may be verified for the TM polarization in order to verify whether the determined parameters permit AWG 100 to operate as described herein.

An initial step for verifying the determined parameters may include determining an output pitch needed for TM output ports 130 (D_{TM}). The output pitch of TM output ports 130 is a distance from a first point of constructive interference, corresponding to a particular wavelength of TM polarized light of the N wavelengths of light to be output by AWG 100, to a second point of constructive interference corresponding to an adjacent wavelength of TM polarized light of the N wavelengths of light. In other words, the output pitch of the TM output ports 130 is a distance between adjacent TM polarized wavelength channels of AWG 100. The output pitch of TM output ports 130 is shown by the distance marked “D_{TM}” in FIG. 2. In some implementations, D_{TM} may be range from approximately 0.5 microns to approximately 10 microns. D_{TM} may be determined based on the following equation:

$${D}_{TM} = \frac{Ra \times m \times {n}_{g \_ TM}}{{n}_{slab \_ TM} \times {n}_{wg \_ TM} \times da} \times d λ$$

Here, D_{TM} is calculated as 4.4 microns (e.g., D_{TM}=[(113.64 microns×2×4.46)/(2.40×1.924×1 micron)]×0.02 microns=4.4 microns). In this example, the determined focal length of output slab 120 causes the points of constructive interference of the N wavelengths of TM polarized light to be approximately 4.4 microns apart at the end of output slab 120.

A next step for verifying the determined parameters may include determining an angular dispersion for the center wavelength for the TE polarization (θ_{TE}), and an angular dispersion for the center wavelength for the TM polarization (θ_{TM}). As described below, θ_{TE} and θ_{TM} may be used to determine whether any point of constructive interference for a wavelength of TE polarized light is near and/or overlaps any point of constructive interference for a wavelength of TM polarized light at the output side of output slab 120. The angular dispersion for a given wavelength differs for TE polarized light and TM polarized light due to the birefringence of the material. An example illustrating θ_{TE} and θ_{TM} of the center wavelength of light is shown in FIG. 2. θ_{TE} and θ_{TM} may be determined using the following equations:

$$sin {θ}_{TE} = \frac{{n}_{wg \_ TE} \times Δ L - m \times {λ}_{c}}{{n}_{slab \_ TE} \times da}$$

$$sin {θ}_{TM} = \frac{{n}_{wg \_ TM} \times Δ L - m \times {λ}_{c}}{{n}_{slab \_ TM} \times da}$$

Here, θ_{TE} is calculated as 0 degrees, or 0 radians (e.g., sin θ_{TE}=[(2.235×1.17 microns)−(2×1.31 microns)]/(2.93×1 micron)→θ_{TE}≈0.000 degrees≈0.000 radians), and θ_{TM} is calculated as 8.74 degrees, or 0.1525 radians (e.g., sin θ_{TM}=[(1.924×1.17 microns)−(2×1.31 microns)]/(2.40×1 micron)→θ_{TM}≈8.74≈degrees 0.1525 radians). Next, a distance between the points of constructive interference for TE polarized light and TM polarized light of the center wavelength (Gap_{TE-TM}) may be determined based on θ_{TE} and θ_{TM} using the following equation:

Gap_{TE-TM}=Ra×|θ_{TE}−θ_{TM}|

Here, Gap_{TE-TM} is calculated as 17.34 microns (e.g., 113.64 microns×|10−0.1525|)=17.34 microns). As such, in this example, the point of constructive interference for TE polarized light of the center wavelength lies 17.34 microns away from the point of constructive interference at the output end of output slab 120. Gap_{TE-TM} is illustrated in FIG. 2 as a distance between points marked “C” and “D.” In some implementations, Gap_{TE-TM} may be within a range from approximately 2 microns to approximately 100 microns. FIG. 2 suggests that θ_{TE} and θ_{TM} may have the same magnitude, but this is only an illustration. In this numerical example, θ_{TE} is identified as approximately 0.000 degrees (i.e., point C overlapping point B) while θ_{TM} is approximately 8.74 degrees. In order to ensure that no TE output port overlaps a TM in this example, Gap_{TE-TM} should be large enough such that two TE output ports 125 and two TM output ports 130 can be arranged in Gap_{TE-TM} without overlap. In this example, two TE output ports need approximately 6.4 microns of distance (e.g., 2×3.2 microns=6.4 microns), and two TM output ports 130 need approximately 8.8 microns of distance (e.g., 2×4.4 microns=8.8 microns). Thus, Gap_{TE-TM} is large enough to allow for this design of AWG 100 to operate as described herein (e.g., since 6.4 microns+8.8 microns=15.2 microns<17.34 microns).

Notably, the equations and calculations described in the above-described design of AWG 100, as well as the number, arrangement, and size of components shown in FIG. 2 are provided merely as examples. In practice, AWG 100 may be designed in another manner and/or may include additional components, fewer components, different components, differently arranged components, differently sized components, or the like, than those shown in FIG. 2.

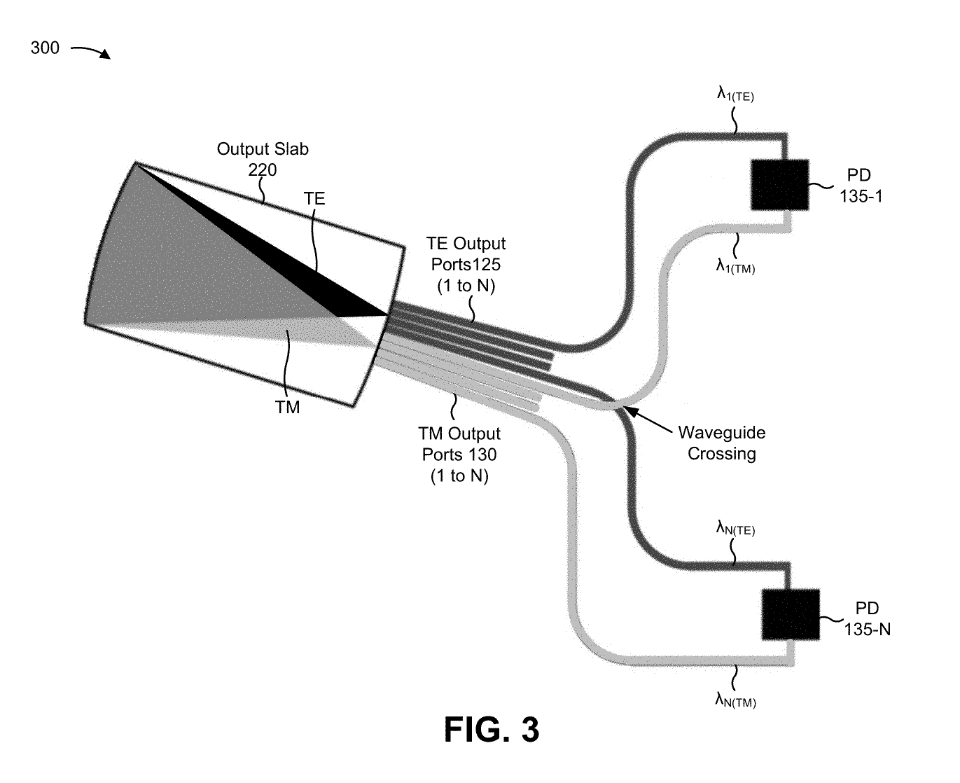

FIG. 3 is a diagram showing a manner in which N TE outputs of AWG 100 may be combined with the N TM outputs of AWG 100 in order to form N outputs. As shown in FIG. 3, in some implementations, AWG 100 may designed to operate with a set of N photodetectors 135 (e.g., photodetector 135-1 through photodetector 135-N).

Photodetector 135 includes a device capable of converting one or more optical signals (e.g., beams of light) into an electrical signal (e.g., a voltage, a current). As shown in FIG. 3, in some implementations, photodetector 135 may receive TE polarized light of a given wavelength and TM polarized light of the given wavelength, and convert the TE polarized light and the TM polarized light to a single electrical signal. In some embodiments, photodetectors 135 may be replaced with optical combiners to provide a dual polarization optical signal for each wavelength.

As further shown in FIG. 3, each photodetector 135 may be arranged to receive both TE polarized light and TM polarized light of a particular wavelength. For example, photodetector 135-1 may receive TE polarized light of a first wavelength (e.g., λ₁) from TE output port 125-1 and TM polarized light of the first wavelength from TM output port 130-1. As another example, photodetector 135-N may receive TE polarized light of a second wavelength (e.g., λ_{N}) from TE output port 125-N and TM polarized light of the second wavelength from TM output port 130-N. Here, each photodetector 135 may convert the received TE polarized light and TM polarized light in order to form a set of N outputs, and may provide the set of N outputs. In some implementations, AWG 100 may include multiple waveguide crossings (e.g., points of overlap between output ports) in order to route waveguides to allow photodetectors 135 to receive a same wavelength of TE polarized light and TM polarized light, as shown in FIG. 3.

The number, arrangement, widths, lengths, etc. of components of AWG 100 shown in FIG. 3 are provided as examples, and are exaggerated for illustrative purposes. In other words, AWG 100 may include additional components, fewer components, different components, differently arranged components, differently sized components, or the like, than those shown in FIG. 3. For example, in some implementations, AWG 100 may be designed to operate with 2N photodetectors 135 (e.g., rather than N photodetectors). In such a case, each of the 2N photodetectors may receive a single output including a particular wavelength of light (e.g., from a TE output port 125), and may convert the single output to a first electrical signal. The first electrical signal may then be combined with a second electrical signal (e.g., generated by another photodetector 135 from an output of a TM output port 130 that includes the particular wavelength of light). In this way, a need for waveguide crossings may be eliminated, thereby improving optical performance of AWG 100.

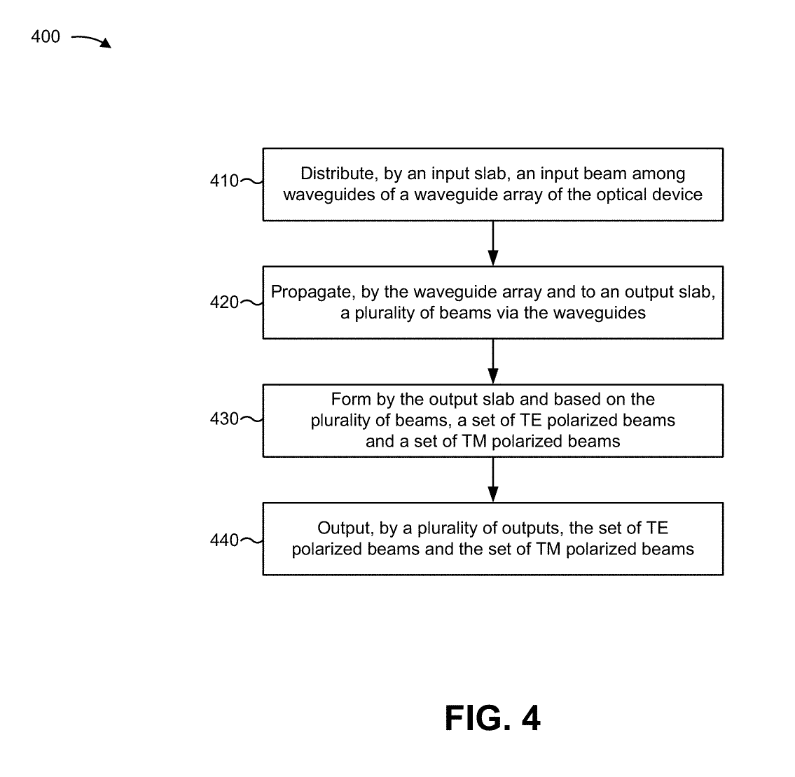

FIG. 4 is a diagram of an example process 400 associated with operation of AWG 100. As shown in FIG. 4, process 400 may include distributing, by an input slab, an input beam among waveguides of a waveguide array (block 410). For example, input slab 110 may distribute an input beam among waveguides of waveguide array 115, as described above. Here, the input beam may include multiple wavelengths of TE polarized light and TM polarized light, as described above.

As further shown in FIG. 4, process 400 may include propagating, by the waveguide array and to an output slab, a plurality of beams via the waveguides (block 420). For example, waveguide array 115 may propagate, to output slab 120, a plurality of beams formed by the distribution of the input beam among the waveguides, as described above.

As further shown in FIG. 4, process 400 may include forming, by the output slab and based on the plurality of beams, a set of TE polarized beams and a set of TM polarized beams (block 430). For example, output slab 120 may form, based on the plurality of beams, a set of TE polarized beams and a set of TM polarized beams, as described above. Here, a TE polarized beam, of the set of TE polarized beams, may include TE polarized light of a particular wavelength of light, and a TM polarized beam, of the set of TM polarized beams, may include TM polarized light of the particular wavelength of light, as described above.

As further shown in FIG. 4, process 400 may include outputting, by a plurality of outputs, the set of TE polarized beams and the set of TM polarized beams (block 440). For example, TE output ports 125 and TM output ports 130 may output the set of TE polarized beams and the set of TM polarized beams, respectively, as described above.

Although FIG. 4 shows example blocks of process 400, in some implementations, process 400 may include additional blocks, fewer blocks, different blocks, or differently arranged blocks than those depicted in FIG. 4.

Implementations described herein provide a dual polarization (i.e., polarization insensitive) AWG, for use as a 1×N demultiplexer, that includes 2N outputs, where a first set of N outputs provides TE polarized light for a set of N wavelengths, and a second set of N outputs provides TM polarized light for the set of N wavelengths. In some implementations, birefringence of a material from which the dual polarization AWG is formed may be accounted for in the design of the dual polarization AWG in order to allow for separation of the TE polarized outputs and the TM polarized outputs.

The foregoing disclosure provides illustration and description, but is not intended to be exhaustive or to limit the implementations to the precise form disclosed. Modifications and variations are possible in light of the above disclosure or may be acquired from practice of the implementations.

For example, while implementations described herein are described in the context of using AWG 100 as a demultiplexer, in some implementations, AWG 100 may be used a multiplexer for multiplexing N TE input beams of N corresponding wavelengths of light, and N TM input beams of the N corresponding wavelengths of light, to form an output beam that includes TE polarized light and TM polarized light of the N wavelengths of light.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A 1×N demultiplexer, comprising:
an input slab to distribute an input beam, including one or more wavelengths of light, among a plurality of waveguides of a waveguide array,
a wavelength of light, of the one or more wavelengths of light, comprising transverse-electric (TE) polarized light and transverse-magnetic (TM) polarized light;
the waveguide array to propagate, to an output slab, a plurality of beams via the plurality of waveguides,
the plurality of beams to be formed by the distribution of the input beam within the input slab to the plurality of waveguides;
the output slab to cause a set of N TE polarized beams and a set of N TM polarized beams to be formed based on interference among the plurality of beams within the output slab,
a TE polarized beam, of the set of N TE polarized beams, including the TE polarized light of the wavelength of light, and
a TM polarized beam, of the set of N TM polarized beams, including the TM polarized light of the wavelength of light; and
a set of N TE output ports and a set of N TM output ports coupled to the output slab,
a TE output port, of the set of N TE output ports, to receive the TE polarized beam of the set of N TE polarized beams, and
a TM output port, of the set of N TM output ports, to receive the TM polarized beam of the set of N TM polarized beams.

2. The 1×N demultiplexer of claim 1, where the input slab, the waveguide array, the output slab, the set of N TE output ports, and the set of N TM output ports are arranged on a single chip, of a plurality of chips, on a wafer.

3. The 1×N demultiplexer of claim 1, where the input slab, the waveguide array, the output slab, the set of N TE output ports, and the set of N TM output ports are formed of silicon.

4. The 1×N demultiplexer of claim 1, where, at an output surface of the output slab, a first output port, of the set of N TE output ports, is positioned between a second output port, of the set of N TM output ports, and a third output port of the set of N TM output ports,
the first output port being associated with outputting a particular TE polarized beam of the set of N TE polarized beams,
the second output port being associated with outputting a first TM polarized beam of the set of N TM polarized beams, and
the third output port being associated with outputting a second TM polarized beam of the set of N TM polarized beams.

5. The 1×N demultiplexer of claim 1, where a first output pitch, associated with the set of N TE polarized beams, is different from a second output pitch associated with the set of N TM polarized beams.

6. The 1×N demultiplexer of claim 1, where an output pitch for the set of N TE output ports is in a range from 0.5 microns to 10 microns and an output pitch for the set of N TM output ports is in a range from 0.5 microns to 10 microns.

7. The 1×N demultiplexer of claim 1, where a first free spectral range, associated with the set of N TE polarized beams, is different from a second free spectral range associated with the set of N TM polarized beams.

8. The 1×N demultiplexer of claim 1, where a distance between a first output port, of the set of N TE output ports, and a second output port, of the set of N TM output ports, is in a range from 2 microns to 100 microns,
the first output port corresponding to a particular TE polarized beam of the set of N TE polarized beams,
the second output port corresponding to a particular TM polarized beam of the set of N TM polarized beams, and
the particular TE polarized beam and the particular TM polarized beam including a same wavelength of light of the one or more wavelengths of light.

9. The 1×N demultiplexer of claim 1, where a difference in angular dispersion between the set of N TE polarized beams and the set of N TM polarized beams in the output slab provides a gap between the set of N TE output ports and the set of N TM output ports.

10. The 1×N demultiplexer of claim 1, further comprising:
a photodetector to combine a particular TE polarized beam, of the set of N TE polarized beams, and a particular TM polarized beam, of the set of N TM polarized beams, to form a combined beam,
the particular TE polarized beam and the particular TM polarized beam including a same wavelength of light of the one or more wavelengths of light.

11. The 1×N demultiplexer of claim 1, where the waveguide array is to:
emit the plurality of beams into the output slab to create interference patterns at the set of N TE output ports and the set of N TM output ports,
the set of N TE output ports being coupled to the output slab at locations where TE maxima of the interference patterns are located, and
the set of N TM output ports being coupled to the output slab at locations where TM maxima of the interference patterns are located.

12. An optical device, comprising:
an input slab to distribute an input beam, including one or more wavelengths of light, among a plurality of waveguides of a waveguide array,
a wavelength of light, of the one or more wavelengths of light, comprising transverse-electric (TE) polarized light and transverse-magnetic (TM) polarized light;
the waveguide array to propagate, to an output slab, a plurality of beams via the plurality of waveguides,
the plurality of beams to be formed based on the distribution of the input beam among the plurality of waveguides by the input slab;
the output slab to form a set of TE polarized beams and a set of TM polarized beams based on interference among the plurality of beams within the output slab,
a TE polarized beam, of the set of TE polarized beams, including the TE polarized light of the wavelength of light, and
a TM polarized beam, of the set of TM polarized beams, including the TM polarized light of the wavelength of light; and
a set of output ports, coupled to the output slab, to output the set of TE polarized beams and the set of TM polarized beams,
a first subset of output ports, of the set of output ports, to output the set of TE polarized beams, and a second subset of output ports, of the set of output ports, to output the set of TM polarized beams,
the first subset of output ports being different from the second subset of output ports.

13. The optical device of claim 12, where, at an output surface of the output slab, the first subset of output ports are spatially separated from the second subset of output ports.

14. The optical device of claim 12, where a first output pitch, associated with the set of TE polarized beams, is different from a second output pitch associated with the set of TM polarized beams.

15. The optical device of claim 12, where a focal length of the output slab is in a range from 20 microns to 1000 microns.

16. The optical device of claim 12, where a difference in angular dispersion between the set of TE polarized beams and the set of TM polarized beams in the output slab provides a gap between the first subset of output ports and the second subset of output ports.

17. The optical device of claim 12, where the waveguide array is to:
emit the plurality of beams into the output slab to create interference patterns at the set of output ports,
the first subset of output ports being coupled to the output slab at locations where TE maxima of the interference patterns are located, and
the second subset of output ports being coupled to the output slab at locations where TM maxima of the interference patterns are located.

18. A method, comprising:
distributing, by an input slab of an optical device, an input beam among waveguides of a waveguide array of the optical device,
the input beam including multiple wavelengths of light,
a wavelength of light, of the multiple wavelengths of light, comprising transverse-electric (TE) polarized light and transverse-magnetic (TM) polarized light;
propagating, by the waveguide array and to an output slab of the optical device, a plurality of beams via the waveguides,
the plurality of beams being formed by the distributing of the input beam among the waveguides;
forming, by the output slab and based on the plurality of beams, a set of TE polarized beams and a set of TM polarized beams,
a TE polarized beam, of the set of TE polarized beams, including the TE polarized light of the wavelength of light, and
a TM polarized beam, of the set of TM polarized beams, including the TM polarized light of the wavelength of light; and
outputting, by a plurality of outputs of the optical device, the set of TE polarized beams and the set of TM polarized beams,
a first set of outputs, of the plurality of outputs, outputting the set of TE polarized beams, and
a second set of outputs, of the plurality of outputs, outputting the set of TM polarized beams,
the first set of outputs being different from the second set of outputs.

19. The method of claim 18, where forming the set of TE polarized beams and the set of TM polarized beams comprises:
emitting the plurality of beams into a first end of the output slab to create interference patterns at the plurality of outputs,
the plurality of outputs being arranged at an opposite end of the output slab from the first end, and
the plurality of outputs being arranged at positions where TE maxima and TM maxima of the interference patterns are located.

20. The method of claim 18, where the input slab, the waveguide array, the output slab, and the plurality of outputs are formed of a birefringent material.
